(19) United States
(12) Patent Application Publication
(10) Pub. No.: US 2026/0300076 A1
(43) Pub. Date: Oct. 1, 2026

(54) RADIATION-HARDENED FIELD-PROGRAMMABLE GATE ARRAYS

(71) Applicant: CARNEGIE MELLON UNIVERSITY, Pittsburgh, PA (US)

(72) Inventors: KENNETH W. MAI, Pittsburgh, PA (US); OGUN ONUR KIBAR, Pittsburgh, PA (US); PRASHANTH MOHAN, Pittsburgh, PA (US); AHMET OGUZ ATLI, Pittsburgh, PA (US)

(73) Assignee: CARNEGIE MELLON UNIVERSITY, Pittsburgh, PA (US)

(21) Appl. No.: 19/013,259

(22) PCT Filed: Jul. 18, 2023
(86) PCT No.: PCT/US2023/027974

§ 371 Date: Jan. 8, 2025

Related U.S. Application Data
(60) Provisional application No. 63/390,081, filed on Jul. 18, 2022.

(51) Int. Cl. G06F 21/76; G06F 11/07

(52) U.S. Cl. CPC G06F 21/76; G06F 11/073

(57) ABSTRACT

Disclosed herein is a novel system and method for detecting, localizing, and correcting configuration upsets of an SRAM-based FPGA design caused by radiation exposure. The radiation-hardened FPGA uses embedded strike sensors distributed throughout the FPGA fabric, coupled with an error handler to correct the upsets using a redundant on-chip copy of the configuration.

### RELATED APPLICATIONS

This application is a national phase filing under 35 U.S.C. § 371 claiming the benefit of and priority to International Patent Application No. PCT/US23/27974, filed Jul. 18, 2023, entitled “RADIATION-HARDENED FIELD-PROGRAMMABLE GATE ARRAYS”, which claims the benefit of U.S. Provisional Patent Application No. 63/390,081, filed Jul. 18, 2022, the contents of which are incorporated herein in their entireties.

### GOVERNMENT INTEREST

This invention was made with U.S. Government support under contract DE-NA0003525 awarded by U.S. Department of Energy. The U.S. Government has certain rights in the invention.

### BACKGROUND

Radiation environments contain particles that may cause errors in integrated circuits (ICs). Heavy ions and protons that travel from the Sun or from outside of the solar system, or that are trapped by the Earth's magnetic fields warrant extra design considerations for ICs used, for example, in space applications. Particles in space cannot penetrate through the Earth's atmosphere, but they do collide with atmospheric gases and form secondary neutrons, which can lead to malfunctions in terrestrial applications. Neutrons need to be accounted for in ground applications, particularly in large-scale and high-reliability systems, for example, autonomous cars and data centers.

Particles can pass through semiconductors and directly or indirectly generate a charge. Heavy ions generate charge directly in form of electron-hole pairs, whereas protons typically generate charge indirectly through high-energy byproducts of their reactions with silicon atoms. Similar to protons, neutrons also generate charge indirectly, as their reactions with silicon atoms can generate high-energy particles which can generate charge.

Exposure to radiation can induce long-term and short-term error modes in integrated circuits. Long-term errors are the gradual result of continuous exposure to radiation, stemming from the accumulation of structural damages caused by particles and eventually leading to device failures. On the other hand, short-term errors are caused by ionization resulting from collision of high-energy particles with semiconductors.

Radiation can also cause cumulative effects in semiconductors that lead to long-term error modes which occur as a result of many radiation events over time. Accumulation of radiation in semiconductors, called Total Ionizing Dose (TID), causes gradual changes to transistor characteristics due to charge build-up in transistor oxides and displacement of atoms in semiconductor structure.

Field programmable gate arrays (FPGAs) are programmable integrated circuits having a programmable logic fabric and interconnects that allow users to configure the hardware post-manufacturing. Due to their compelling performance, energy and cost efficiency and flexibility, they are widely deployed across a range of applications such as aerospace, automotive, medical, data centers, and high-performance computing. Most FPGAs are reprogrammable, enabling designers to program FPGAs to handle many different tasks, fix bugs, and update applications post-deployment.

The logic fabric of an FPGA is formed by logic clusters called configurable logic blocks (CLBs) comprised of basic logic elements (BLEs) that provide logic storage functionality through crossbar muxes (XBAR), look-up tables (LUTs) and flip-flops (FF). The XBAR consists of programmable muxes that map CLB inputs from the interconnect into the LUTs. The LUTs provide logic functionality through programmable muxes that receive inputs from configuration cells and select bits from XBAR outputs.

CLBs are connected with each other through switch boxes (SBs) and connection blocks (CBs) in a programmable interconnect. SBs serve as junctions of horizontal and vertical interconnect channels where channels and CLB outputs can turn corners or extend further in the interconnect through programmable muxes. CBs are comprised of programmable muxes that select from interconnect channels and connect the selected signals to CLB inputs. A combination of a CLB, an SB, and two CBs forms a tile, a 2D array which forms the core of the FPGA fabric. Inputs and outputs of the FPGA are connected to the fabric through the peripheral interconnect including SBs and CBs.

To implement a design on an FPGA, users program the configurable logic and interconnect with a configuration bitstream that is stored on a configuration memory inside the FPGA. The configuration memory is often locally distributed within CLBs, SBs, and CBs as frames of configuration cells.

FPGAs generally hold their configuration locally on anti-fuse, flash, or static random access memory (SRAM)-based configuration cells. Anti-fuse is an electrical device that has a high-resistance path which can be permanently programmed with a large current. Anti-fuse memory cells are non-volatile and highly resistant to single event upset (SEU) errors, but they are only one-time programmable, and therefore lose much of their attractiveness when used to implement FPGAs. Flash-based cells have largely taken place of anti-fuse cells thanks to their reprogrammable nature. Flash transistors consist of two gates which store the value by trapping electrons on a floating gate and are non-volatile. Although flash-based configuration cells are robust against SEUs, they are susceptible to long-term radiation effects. Additionally, anti-fuse and flash technologies are not available at every process node and typically lag their CMOS counterparts by multiple years. Finally, most FPGAs use SRAM-based cells for configuration storage. SRAM cells are reprogrammable and do not have availability issues, but they are volatile and exhibit susceptibility to SEUs.

The reprogrammable nature of FPGAs can make them particularly vulnerable to radiation-induced SEUs, which are bit flips that can occur when high-energy particles strike the semiconductor. Because FPGAs typically store configuration in SRAM-based configuration cells, SEUs can potentially break functionality of an application implemented on the FPGA.

Circuit elements have been becoming denser with process scaling. This has led to a larger number of elements becoming susceptible to single particle strikes and to multiple bit upsets to becoming more common. This requires the traditional countermeasures used to tackle SEUs in FPGAs to become more complex and costly or to involve high latencies.

When hardening FPGAs, the focus is typically on SEUs in FPGA configuration memory, which can dominate the other types of errors. A combination of hardening methods at different layers can be used to make FPGAs and designs implemented on the FPGA fabric more tolerant to configuration errors. These layers include hardening the FPGA configuration memory by technology or by design, hardening the application implemented on the FPGA, and adding error detection and handling mechanisms to detect and correct errors in FPGA configuration.

These various radiation-induces errors in FPGAs can be addressed at different levels, no single countermeasure can address all vulnerabilities. Countermeasures such as redundant cell topologies and ECC algorithms can be applied to mitigate and detect/correct SEUs in configuration memory but the scaling of CMOS technology has been a detriment to those methods as multi-bit upsets have become more common.

### BRIEF DESCRIPTION OF THE DRAWINGS

By way of example, a specific exemplary embodiment of the disclosed system and method will now be described, with reference to the accompanying drawings, in which:

FIG. 1 is a block diagram of the FPGA in accordance with one embodiment disclosed herein.

FIGS. 2A and 2B are block diagrams showing an FPGA, and a single tile in the FPGA, respectively.

FIG. 3 is a block diagram illustrating the mux of the BLEs.

FIG. 4 is a block diagram illustrating the LUT.

FIG. 5 is a block diagram illustrating the BLE output circuitry.

FIG. 6 is a block diagram illustrating the CLB switch points.

FIG. 7 is a block diagram illustrating the internals of a switch point.

FIG. 8 is a block diagram illustrating connection blocks selecting inputs into the CLBs from the interconnect through configurable muxes.

FIG. 9 is a circuit schematic illustrating an SRAM configuration cell.

FIG. 10 is a block diagram illustrating a configuration cell with distributed tunable SEU sensors.

FIG. 11 is a circuit schematic illustrating a SEU sensor.

FIG. 12 is a block diagram illustrating a sensor frame.

FIG. 13 is a block diagram illustrating sensor frames forming a configuration frame.

FIG. 14 is a block diagram illustrating a memory array used to store the FPGA configuration, sensor data, and redundant block information.

FIG. 15 is a block diagram illustrating the hardware blocks and signals involved in the handling of SEUs in sensors.

FIG. 16 is a flow chart illustrating the decision tree that is executed in the error handler's state machine after a sensor detects an SEU.

FIG. 17 is a block diagram illustrating the hardware blocks and signals involved in the handling of application errors.

FIG. 18 is a flow chart illustrating the decision tree that is executed in the error handler's state machine after an error handling request from the fabric.

FIG. 19A is a block diagram illustrating redundant applications interacting with the error handler; FIG. 19B is a block diagram illustrating a mismatch in DMR outputs.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a novel countermeasure to detect, localize, and correct configuration bitcell upsets of an SRAM-based FPGA design using embedded strike sensors distributed throughout the FPGA configuration memory, coupled with an error handler to correct the upsets.

In one embodiment, the sensors are interspersed with the configuration memory ceils of a radiation-hardened FPGA, one sensor per two configuration cells. An on-chip error handler receives localized error flags from the sensors and works with an on-chip MRAM-based non-volatile memory to correct errors. The error handler also communicates with the logic fabric through dedicated fabric I/Os, allowing applications to request reconfiguration from the error handler, which can be used as a higher latency safety net for the sensors.

### DETAILED DESCRIPTION

There are multiple hardening methods that can be provided on different layers to mitigate the effects of radiation on FPGAs. SEUs in configuration memory are a major concern because FPGAs consist of millions of configuration cells.

The claimed embodiments are directed to an open-source radiation hardened FPGA. Its architecture, implementation and the radiation hardening features it contains are disclosed. The FPGA is based on a traditional island-style architecture and consists of a 2D array of configurable logic blocks (CLBs), switch boxes (SBs), and connection blocks (CBs). The FPGA is implemented using a semi-custom approach wherein sub-blocks of FPGA tiles are designed manually and everything is integrated using automated standard cell flow.

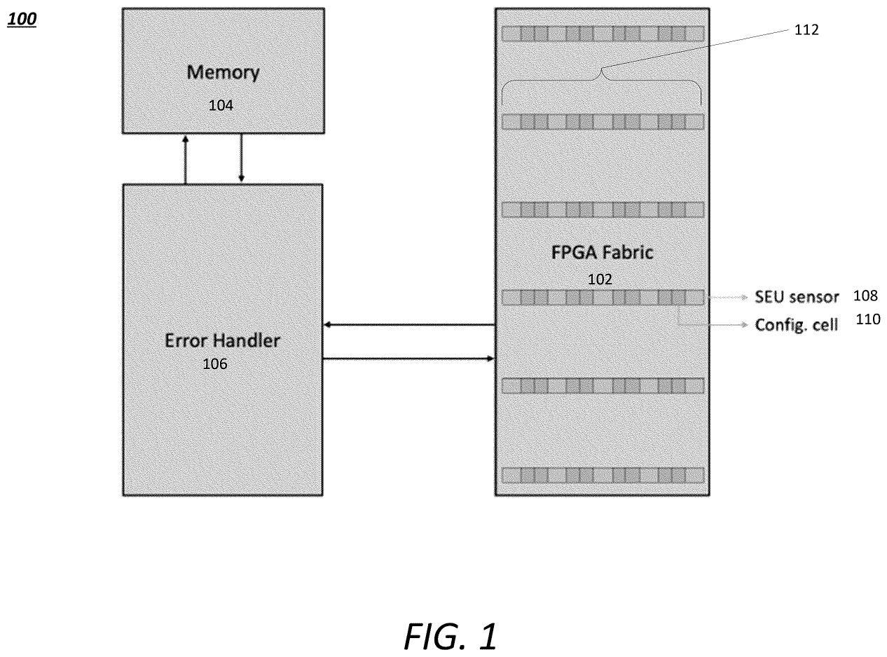

FIG. 1 shows a block diagram of the radiation-hardened FPGA of the present invention, which consists of a configuration memory 102 with distributed SEU sensors 108, an error handler 106 designed to work in tandem with sensors 108 and redundant applications stored in memory 104 to detect and correct errors. The SEU sensors 108 provide low-latency error detection and help the on-chip error handler 106 to identify and correct errors. The error handler 106 also has means of communicating with the application on the FPFA fabric 102 through dedicated fabric I/O. Using this direct line of communication, applications implemented on fabric 102 can request reconfiguration from error handler 106. This allows redundant applications stored in memory 104 and error handler 106 to work in tandem to detect and correct errors. Memory 104 stores FPGA configuration and other information used by error handler 106 to handle errors detected through sensors 108.

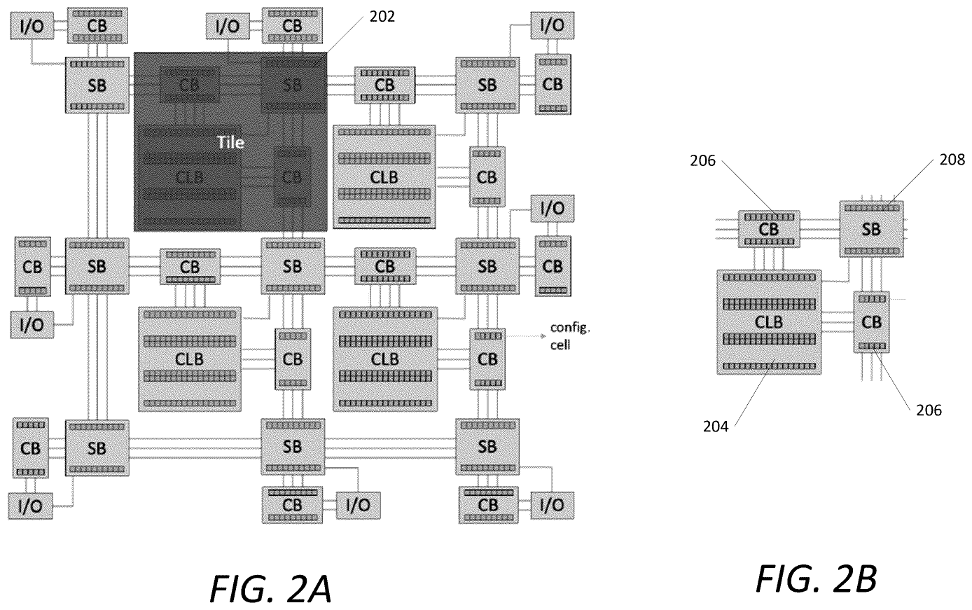

The exemplary FPGA disclosed herein is based on a traditional island-style, which is the most commonly used FPGA architecture in academia and industry. An exemplary island-style FPGA of the type with which the present invention could be used is shown in FIGS. 2-8.

A block diagram of a 2×2 FPGA fabric is shown in FIG. 2A and a single tile is shown in FIG. 2B, wherein each tile 202 consists of a configurable logic block (CLB) 204, a switch box (SB) 208, and two connection blocks (CBs) 206. CLBs 204 provide logic and storage functionality, whereas SB 208 and CBs 206 form the programmable interconnect and connect CLBs 204 with each other. The configuration of the FPGA is stored locally in CLBs 204, SBs 208, and CBs 206 inside SRAM-based configuration cells.

The CLBs provide logic and storage functionality to the FPGA fabric. The CLBs contain six bask logic elements (BLEs), each of which consist of a crossbar (XBAR), six 6-input lookup tables (LUTs) that are factorable into two 5-input LUTs, flip-flops, and an output mux.

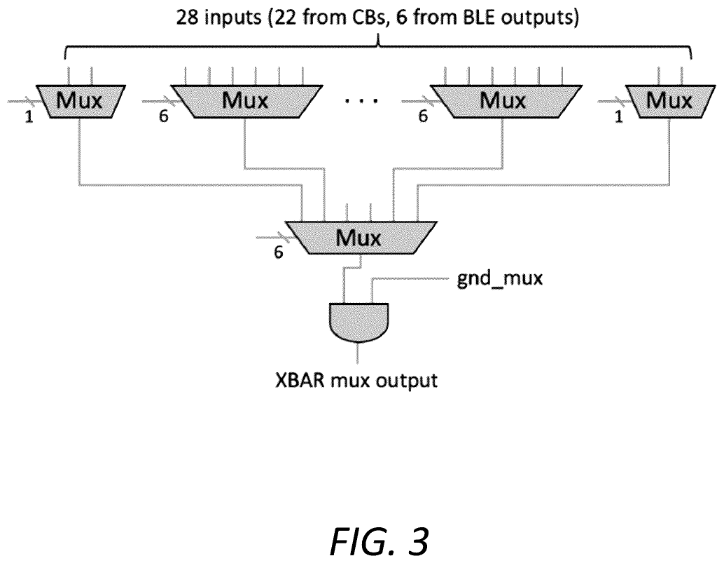

Each BLE consists of a crossbar that receives 22 inputs from connection blocks and 6 inputs from BLE outputs inside the CLB. The crossbar maps the inputs into LUT inputs through configurable 28:1 muxes. Configuration bits are connected to select inputs of muxes. Each mux is implemented in two stages as shown in FIG. 3, wherein the first stage has two 2:1 and four 6:1 muxes, and the second stage has a 6:1 mux. The 2:1 muxes are controlled by a single configuration bit, whereas the 6:1 muxes are one-hot and are configured by six configuration cells. The last stage is an AND gate which receives a control signal (gnd_mux) that can ground the mux output to avoid high current consumption until the correct configuration is loaded into the FPGA. The AND gate at the end receives a control signal (gnd_mux) that can ground the mux output before the correct configuration is loaded onto the FPGA.

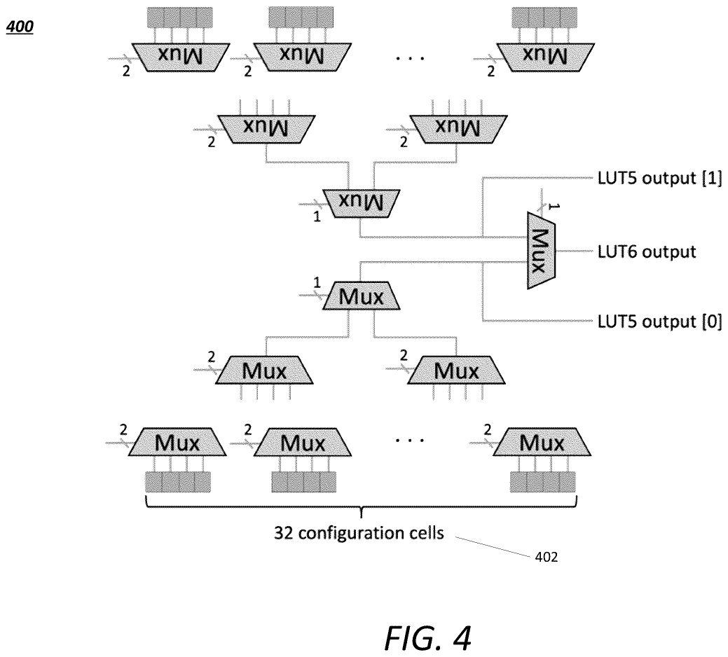

Each BLE includes a 6-input LUT 400 that is fracturable into two 5-input LUTs, as shown in FIG. 4. The LUT consists of a 64:1 mux which receives 32 configuration bits 402 as inputs and 6 XBAR outputs as select signals. The mux is implemented in four stages as two 4:1 muxes and two 2:1 muxes. When programmed as two 5-input LUTs, the last mux stage is not used and the previous stages serve as two 32:1 muxes, the outputs of which are taken from the LUT 400.

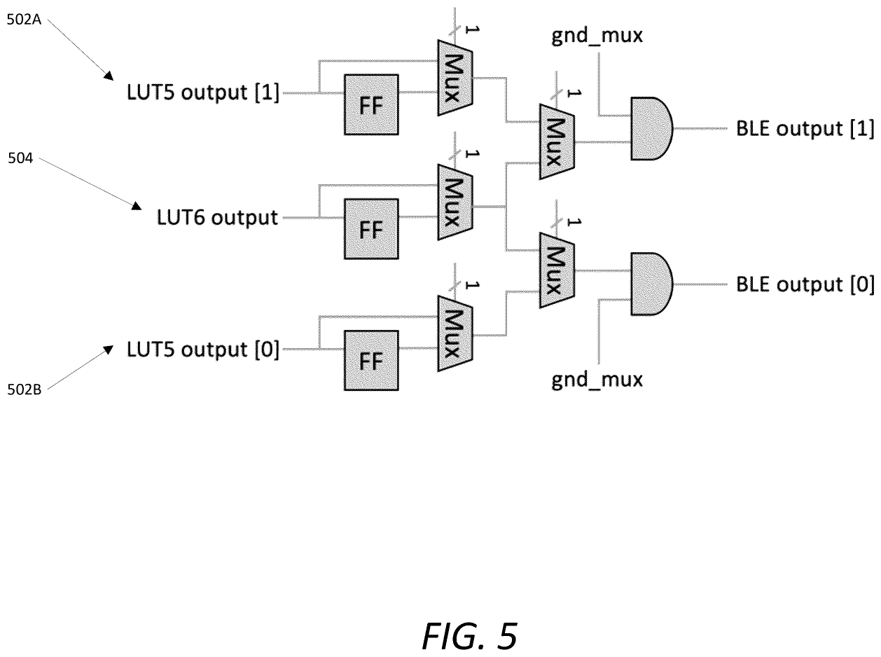

FIG. 5 illustrates the BLE output scheme. LUT outputs can be taken outside the BLE or stored inside flip-flops. Each BLE consists of three flip-flops, two of which 502A, 502B receive the 5-input LUT outputs and one 504 which receives the 6-input LUT output. Configurable muxes select between LUT and flip-flop outputs, and an AND gate which receives the gnd_mux signal takes the mux output outside the BLE.

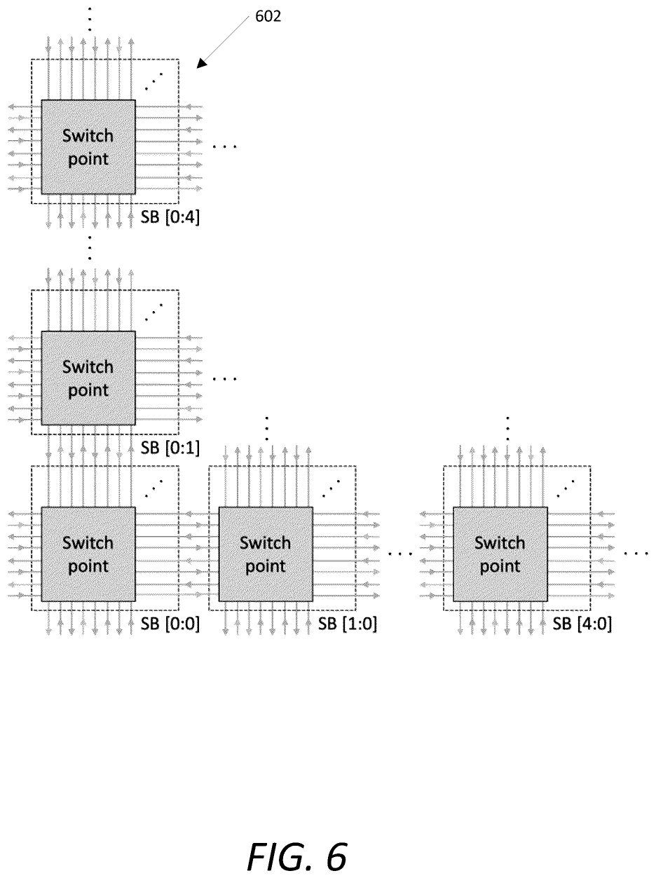

CLBs are connected with each other through a programmable interconnect. The interconnect channels have a length of four, which means each wire is driven by the switch box of the origin tile 202, extends across four tiles, and terminates at the switch box inside the fourth tile. Switch boxes are junctions of horizontal and vertical channels wherein interconnect wires and CLB outputs can turn corners or extend further in the interconnect through programmable muxes. The wires are grouped into bundles of eight going into the switch box, and each bundle connects to a switch point, sub-blocks of switch box that drive wires in every direction. Because the channels have a length of four, only one fourth of the wires are driven by switch points 602, as shown in FIG. 6, and the connection pattern repeats every four tiles.

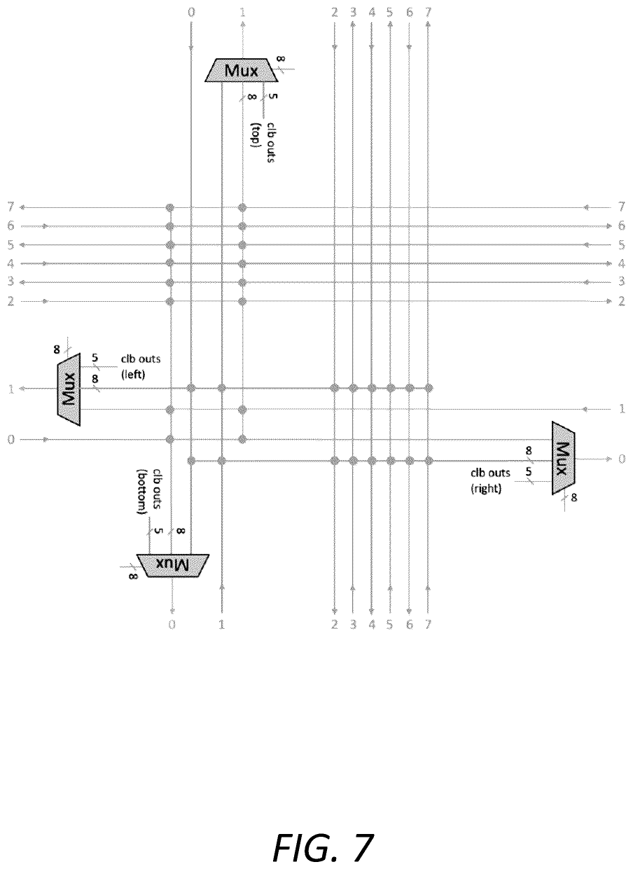

Switch points 602 drive wires in different directions through four configurable 14:1 muxes. Muxes inside switch points 602 receive eight signals from the perpendicular direction, five CLB outputs, and one from the same direction as shown in FIG. 7. Each 14:1 mux includes two 7:1 muxes in the first stage and a 2:1 mux in the second stage. The mux output is connected to an AND gate which can be used to ground the switch box outputs until the FPGA is configured.

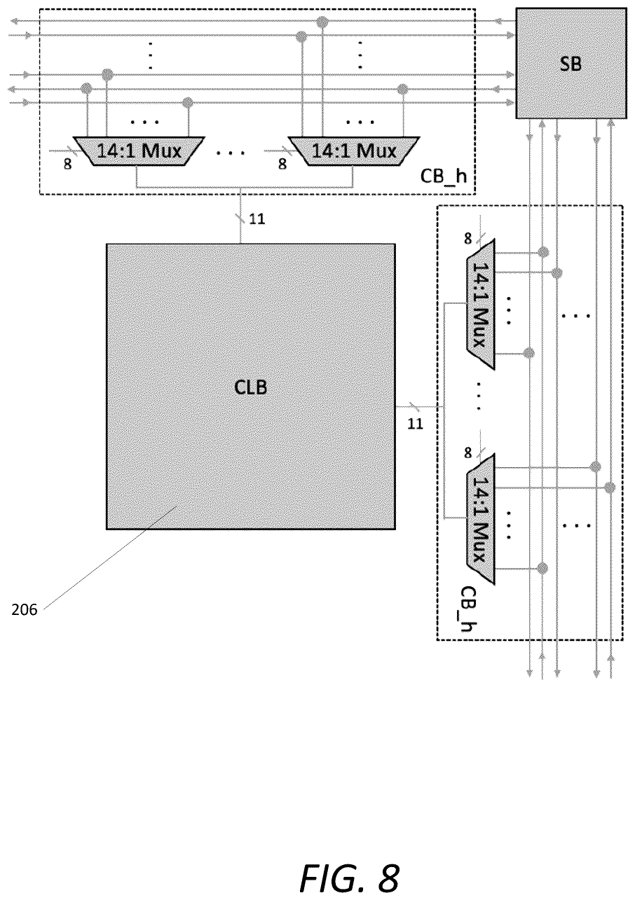

Connection blocks 206 select inputs into CLBs 204 from the interconnect through configurable muxes. The FPGA tiles 202 consist of two connection blocks 206, one that selects from the vertical channel and one that selects from the horizontal channel, as shown in FIG. 8. Each connection block 206 contains eleven 14:1 configurable muxes that are identical to the 14:1 muxes inside switch boxes 208. The first stage of the muxes is formed by two 7:1 muxes, and the second stage includes a 2:1 mux. An AND gate at the mux output can be used to ground the CB outputs until the FPGA is programmed with the correct configuration.

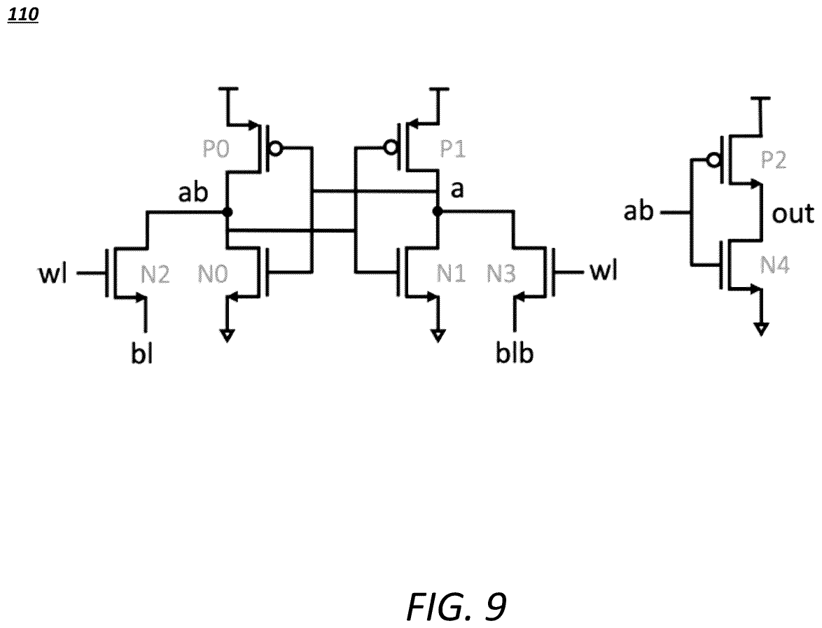

The FPGA configuration is stored locally in banks of SRAM-based configuration cells 110 inside CLBs 204, CBs 206, and SBs 208. The configuration cells 110 consist of an SRAM cell to store the configuration bit and an inverter to take the stored value out to the FPGA fabric as shown in FIG. 9. An SRAM configuration cell 110 consists of a cross-coupled inverter and two access transistors. The cross-coupled inverter holds the state stored in the cell and is formed by two PMOS and two NMOS transistors (PO, Pl, NO, and N1 in FIG. 9). The two access transistors (N2 and N3) are used to write to and read from the cell. When writing, the word line (wl) is pulled high to activate the access transistors, and the bit lines (bl and blb) are set to complementary values depending on the data to be written to the cell. When reading, the bit lines are left floating and the word line is pulled high. The storage nodes (a and ab) drive the bit lines, which can be used to determine the value stored inside the cell.

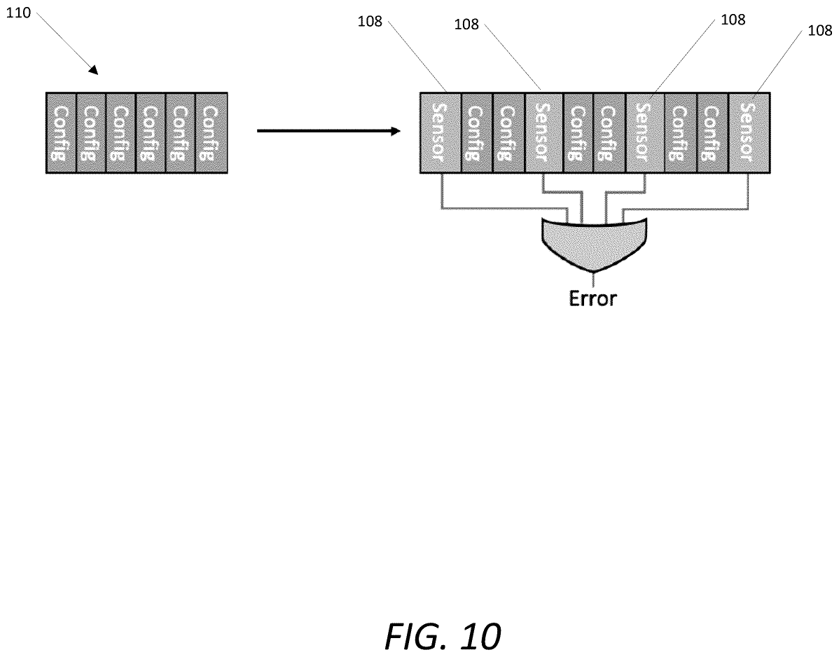

To detect SEUs in configuration cells 110, tunable SEU sensors 108 are distributed among configuration cells. Configuration cells 110 experience an increased charge sharing with reduced spacing. Because of this, in one exemplary embodiment, a sensor cell 108 is added for every two configuration cells 110 and at the edges of configuration storage blocks, as illustrated in FIG. 10. In one exemplary embodiment, sensors 108 are 50% wider than configuration cells. As such, the area overhead inside the configuration memory is 75%. The expectation from sensors 108 is that when a high-energy particle strikes the FPGA and causes an SEU in a configuration cell 110, a nearby sensor 108 will also collect charge and change its state. The requirement of the design of sensors 108 entails: (1) being able to hold a reset and an error state to understand there was an error; (2) vulnerability to SEUs, at least as much as the SRAM-based configuration cells; (3) tunability to vary the sensitivity of the sensor in case it is too sensitive or not sensitive enough; (4) writability and readability to reset the sensor and read each sensor output separately; and (5) continuous access to sensor output to immediately raise error flags when there is an SEU. Preferably, the sensors 108 are tuned such that they will indicate an error at a lower level of radiation than a level that would cause an SEU error in a configuration cell 110.

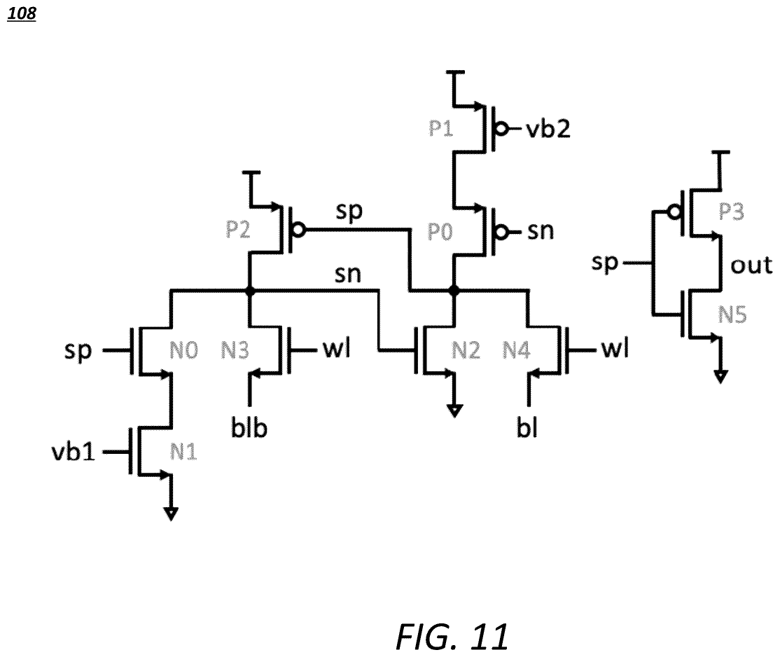

FIG. 11 is a schematic illustrating one embodiment of the sensor circuit. The sensor cell holds the state on two nodes, sp and sn. N0, N1, N2, P0, P1, and P2 hold the state of the sensor through feedback similar to that of an SRAM cell, wherein N1 and P1 are added to tune the sensor sensitivity through two bias voltages. N3 and N4 provide access to the cell, whereas the inverter at the output formed by P3 and NS allow continuous access to the sensor output.

Sensor 108 operates as follows: the word line (wl) is set to 1 to activate N3 and N4, the bit lines (blb and bl) are set to 0 and 1, respectively, and sensor 108 is reset to a known state, sn=0 and sp=1. After reset, sensor 108 is kept at the reset state through weak keepers formed by N0, N1, P0, and P1. The strength of the keepers can be tuned by varying bias voltages vb1 and vb2 to make the sensor more or less vulnerable to SEUs. In the event of a particle strike, drain nodes of P2, N2, N4, and NS can collect charge to pull sp low or sn high. If sufficient charge is collected, P2 or N2 turn on and change the state of sensor 108. Sensor 108 then remains at the error state, sn=1 and sp=0, until reset.

In one exemplary embodiment, sensor cells 108 have the same height as configuration cells 110 and are 50% wider. While laying out the cell, an important design consideration is to achieve maximum correlation between sensors 108 and configuration cells 110 in terms of charge collection. Therefore, the cells are arranged such that sensitive nodes of the sensor cell 108 (i.e., the transistor nodes that collect charge sufficient to cause an SEU) are placed as close as possible to the sensitive nodes of configuration cells 110.

Similar to configuration cells 110, sensor cells 108 also consist of inverters which are added to take the stored value outside. Sensor outputs are grouped through OR gates into error flags, as shown in FIG. 10, which help in the indication of errors without having to continuously read sensors through word lines and bit lines. This helps with detecting SEUs in sensors with very low latency.

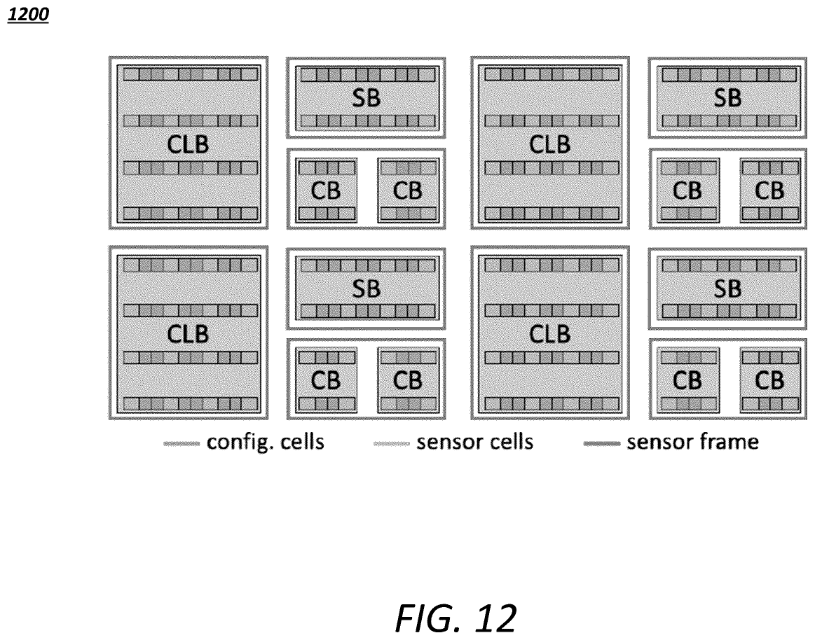

Sensor outputs are grouped into error flags and sensor frames 1200 are formed as shown in FIG. 12. Sensor frames 1200 serve as minimum units of error localization where sensor outputs inside sensor frame 1200 are combined through an OR-tree to obtain an error flag. Each FPGA tile 202 consists of three sensor frames 1200 formed by the CLB 204, the two CBs 206, and the SB 208, all of which have dedicated error flags, whereas each CB 206 and SB 208 in the fabric periphery is also organized as a sensor frame 1200. Each sensor frame 1200 has a unique ID used by the error handler 106 in determining which redundant block is implemented on it, if any, and which configuration frame 112 encompasses the faulty sensor frame.

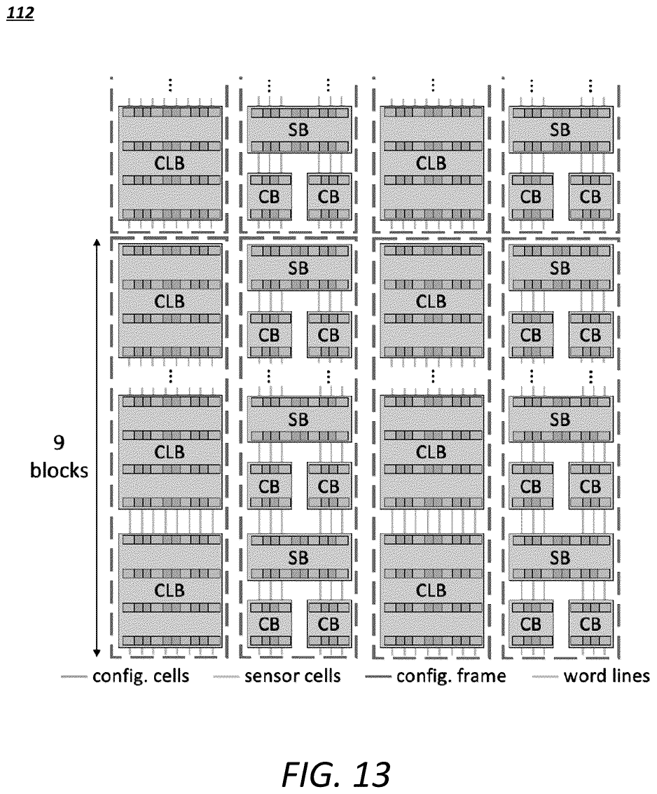

The CLBs 204, CBs 206, and SBs 208 are grouped together by sharing word lines to form configuration frames 112 as illustrated in FIG. 13. Configuration frames 112 are the minimum reconfigurable units of the FPGA. Each frame spans nine tiles vertically and half a tile horizontally, as CLBs 204 are grouped into different configuration frames than CBs 206 and SBs 208.

To configure a frame, a configuration frame ID, a word line number, bit line data, and control signals have to be inserted as inputs to the configuration infrastructure from outside through scan chains or from the on-chip error handler. Each configuration frame 112 has a word line decoder which receives the word line number as an input and outputs a one-hot signal, as only one word line will be activated at a time. Word lines are then shared between the blocks within each configuration frame 112. Unlike word lines, the bit line data bits are directly distributed to the blocks inside configuration frames, where each CLB 204, CB 206, and SB 208 has dedicated bit line drivers with bit line reset as well as write/read circuitry. Control signals are provided to each configuration frame 112 to moderate bit line reset, write/read, and word line activation. Depending on which frame ID is inserted to the configuration infrastructure, only one configuration frame 112 receives valid control bits at a time, whereas other configuration frames stay inactive. The same infrastructure can be used to read out the bitstream through scan chains.

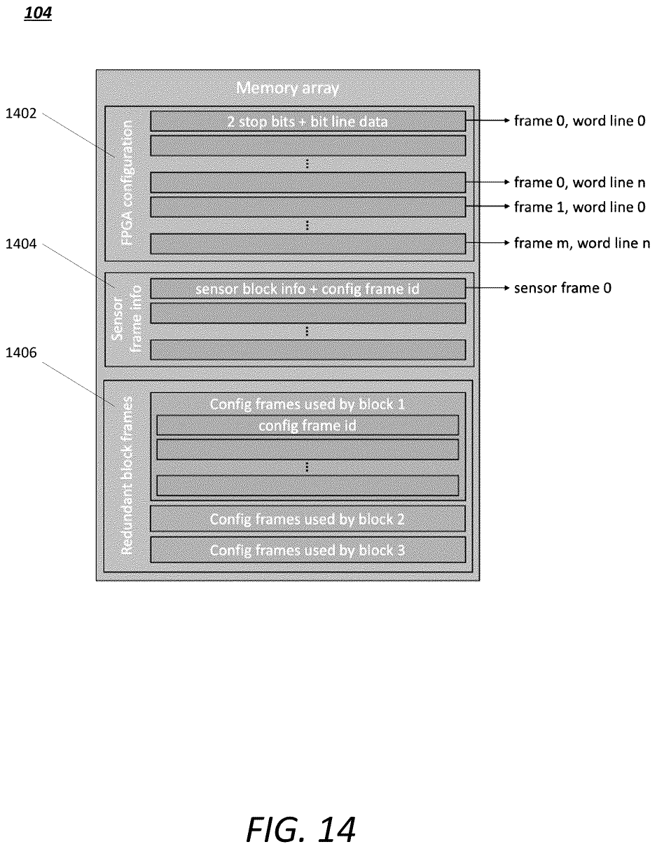

The FPGA configuration, sensor data, and redundant block information is stored in memory 104. FIG. 14 demonstrates the data stored in memory 104. The FPGA configuration data 1402 consists of bit line data for every word line of every configuration frame 112 and 2 stop bits which indicate the last word lines and the last frame. The data is mapped in memory 104 according to the configuration frame ID and word line number. An address formed by the configuration frame ID and word line number is required to access the data.

The sensor frame information 1404 stored in the memory is accessed by using an offset and a sensor frame ID when a sensor detects an SEU and the error handler 106 needs to determine which configuration frame 112 to reconfigure. Data at each address is comprised of sensor block information and a configuration frame ID for every sensor frame in the FPGA. The sensor block information is optionally used when implementing a redundant application on the FPGA to give information to error handler 106 about whether a redundant block, multiple redundant blocks, or neutral blocks such as majority voters are implemented in the sensor frame 1404. The configuration frame ID, on the other hand, informs error handler 106 about the configuration frame 112 to which the sensor frame 1404 belongs.

Redundant block frame 1406 stores information for applications implemented on the FPGA, which is accessed when there is an error in the application and a block needs to be reconfigured. The redundant block frame data is separated into three parts for three redundant blocks and each address is accessed by using an offset, a block number, and a 9-bit frame number. The data at every address consists of a configuration frame ID and is used to identify on which configuration frames each redundant block is implemented.

Traditional error handling mechanisms on FPGAs typically involve scrubbing the entire configuration memory to detect errors, a process which has a high latency. Because such scrubbers do not detect errors quickly, they are commonly used in parallel with a redundant application such as duel or triple modular redundancy (DMR or TMR) that can detect or mask an error in the operation on the fly. However, the two mechanisms typically do not interact with each other. The error handler 106 disclosed herein does not scrub the configuration memory but relies on the SEU sensors 108 and redundant applications to raise error flags and request reconfiguration. SEU errors in sensors 108 are detected in a few dock cycles by processing the error flags coming out of the sensor frames, whereas detection through the application serves as a complementary mechanism to sensors 108 and detects the error when the application's functionality is disrupted. Therefore, the latency of detecting an error through the application depends on when the error affects the application's operation, which can change depending on the application, the input combination, and the error location.

Error handler 106 works together with the SEU sensors 108 and applications running on the fabric 102 to detect and correct errors, and it can directly communicate with the application through dedicated fabric I/Os. When there is an SEU in a sensor 108, error handler 106 identifies the faulty sensor frame, obtains the correct configuration from memory 104, and reconfigures the corresponding configuration frame 112. To correct errors in redundant applications, the error handler expects the application to raise a request for reconfiguration of a redundant block or the entire fabric. Depending on the type of the request, the error handler either reconfigures the configuration frames used by the corresponding redundant block or reconfigures the entire fabric.

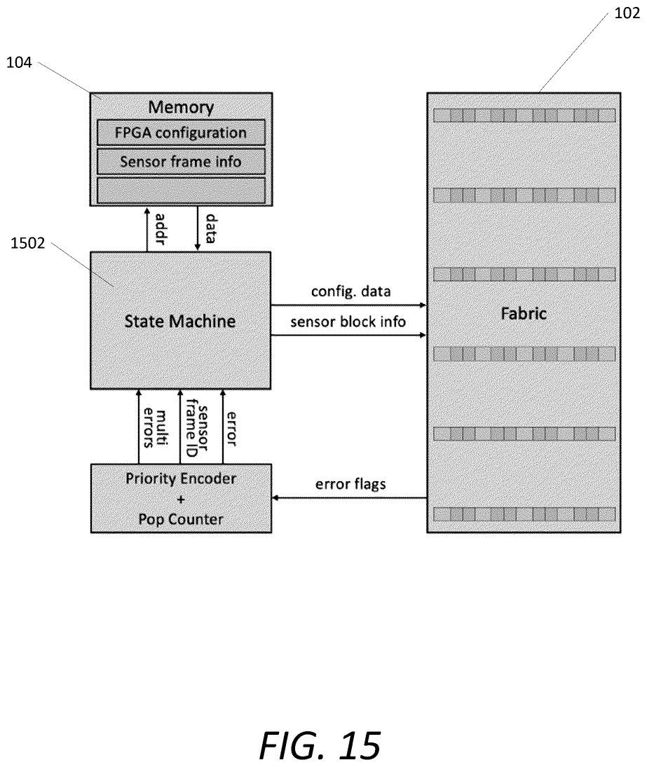

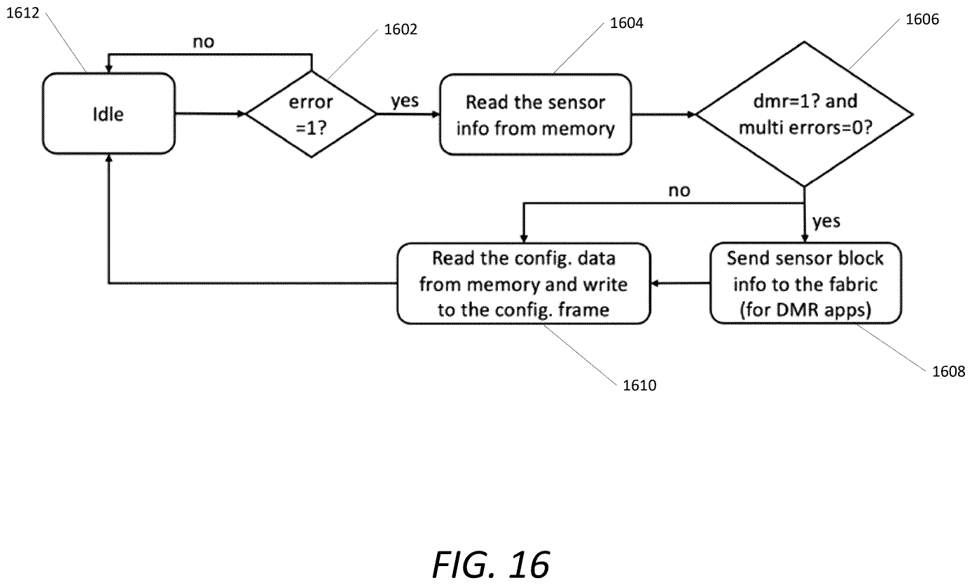

FIG. 15 is a block diagram illustrating the hardware blocks involved in handling of SEUs in sensors and FIG. 16 is a flow chart of the decision tree that is executed in the error handler's state machine 1502. To identify the errors in sensors 108, error handler 106 uses the error flags coming out of every sensor frame 108. The error flags are connected to a priority encoder which outputs the position of the least-significant input bit that is high (i.e., the ID of the faulty sensor frame with the smallest ID number). The flags are also connected to a pop counter that outputs two 1-bit signals indicating whether there is an SEU in sensors 108 and whether multiple sensor frames are indicating errors.

With reference now to FIG. 16, if the error signal from the pop counter is high (1602), the state machine of error handler 106 starts processing the error. It receives the sensor frame ID from the priority encoder output and reads the memory address corresponding to the erroneous sensor frame 108 to obtain the sensor block information as well as the corresponding configuration frame (1604). At this stage, if only a single frame is faulty and the application implemented on the FPGA has DMR (1606), the handler can send the information back to the FPGA fabric (1608) and let the application know which redundant block failed, if any. This information can then be used by DMR applications to vote between the two block outputs in case of a mismatch.

After obtaining the configuration frame ID from the memory, the state machine reconfigures the corresponding configuration frame (1610). To do this, the error handler sends the memory an address comprising a configuration frame and a word line number, reads the bit values in the requested word line, and writes it to the configuration frame. After repeating this for every word line, error handler 106 sends a signal to the FPGA fabric 102 indicating that a reconfiguration was completed and waits for an acknowledgement signal, which ensures that the application processes the information and continues the operation as usual if it was waiting for a reconfiguration. Once the error handler receives the acknowledgement signal from the fabric, it switches back to the idle state (1612).

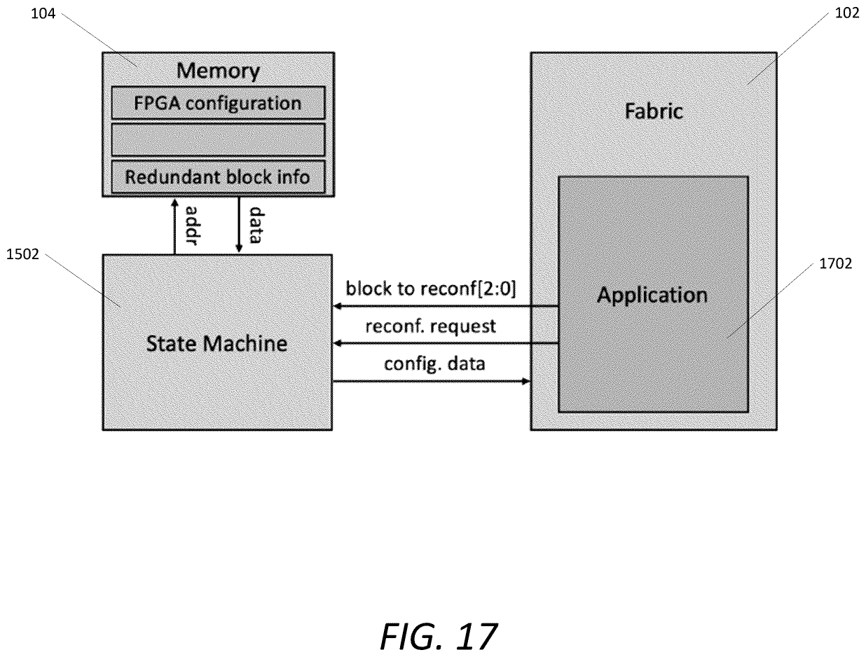

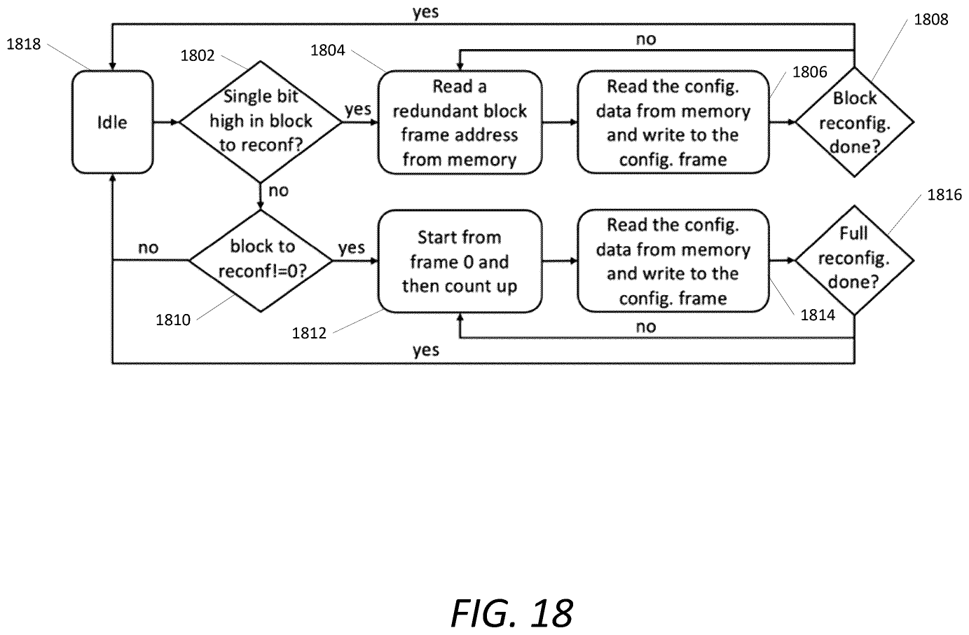

Error handler 106 can directly communicate with the fabric 102 through the fabric I/O, where numerous input and output signals are dedicated for fabric-error handler interaction. This allows error handler 106 to work together with the application running on fabric 102. If the application detects a fault in operation, it can request error handler 106 to reconfigure a redundant block or the entire FPGA. FIG. 17 illustrates the hardware blocks and signals, and FIG. 18 is a flow diagram illustrating the state machine decision tree that is used for handling application errors. Error handler 106 determines whether a redundant block or the entire fabric 102 needs to be reconfigured by processing a 3-bit signal named block to reconfigure that it receives from fabric 102.

Block-level reconfiguration: With reference now to FIG. 18, if only a single bit of the block to reconfigure signal is high (1802), it means that one of the TMR blocks has failed. In this scenario, error handler 106 reconfigures all the configuration frames used by the faulty redundant block and by neutral blocks such as block output comparators. To reconfigure, error handler 106 reads the configuration frame IDs from memory 104 and reconfigures the frames 112 one-by-one (1804, 1806). Block-level reconfiguration is slower than the frame-level reconfiguration achieved through detecting errors through sensors, but since only a part of fabric 102 is reconfigured, it is still faster than reconfiguring the entire fabric 102. The block level configuration completes at 1808.

Fabric-level reconfiguration: Still with reference to FIG. 18, if multiple bits of the 3-bit signal are high, it means none of the redundant block outputs in the application are matching each other (1810). In this case, error handler 106 reprograms the entire fabric 102. To do that, it reconfigures each configuration frame 112 one by one-by-one by reading the configuration data from memory 104 and writing it to fabric 102. This is the slowest error handling scenario since the entire fabric 102 is reconfigured. The full configuration ends at 1816.

In both scenarios, once reconfiguration is completed, error handler 106 sends a signal to the FPGA fabric 102 telling it that the reconfiguration is completed and waits for an acknowledgement signal. This ensures that the application processes the information and finishes at least one operation to see if there is still an error. Once fabric 102 sends the acknowledgement signal to error handler 106, the state machine of the error handler switches back to the idle state at 1818.

Operation of error handler 106 depends on its communication with the memory 104 and the fabric 102. Errors which can break the communication and may cause the error handler's state machine to be stuck To identify these situations, timeout modes are included in the states where error handler 106 expects a signal from the other blocks. Failure to receive a signal with a certain period of time forces the state machine 1502 in error handler 106 to switch to the corresponding timeout state, which can be read by the user through the chip I/Os or scan chains to identify why error handler 106 failed.

Error handler 106 includes counters to count the number of times the error was corrected at the frame-level (detection by sensors), the block-level (TMR application with one redundant block failing), and at the fabric-level (no match between any redundant block output). The number of times sensor information was used to decide between the two DMR outputs is also counted. Error handler 106 includes scan chains to help with configurability as well as testability.

The error handling modes can be enabled or disabled through a scan chain which helps to evaluate their efficiency when used together or separately. Another scan chain programs the wait time for the state machine before switching to a timeout mode. Finally, critical signals such as error counter values can be loaded to an output scan chain to read data out of error handler 106, which allows the user to obtain a snapshot of the status while error handler 106 is still functional.

Error handler 106 is vulnerable to radiation similar to the rest of FPGA 100. An error in error handler 106 can cause unwanted transitions where the state machine can be stuck in a state or a loop and may require outside intervention. To mitigate such errors, the state machine and the scan chains which configure error handler 106 are triplicated, and important signals are voted using majority voters.

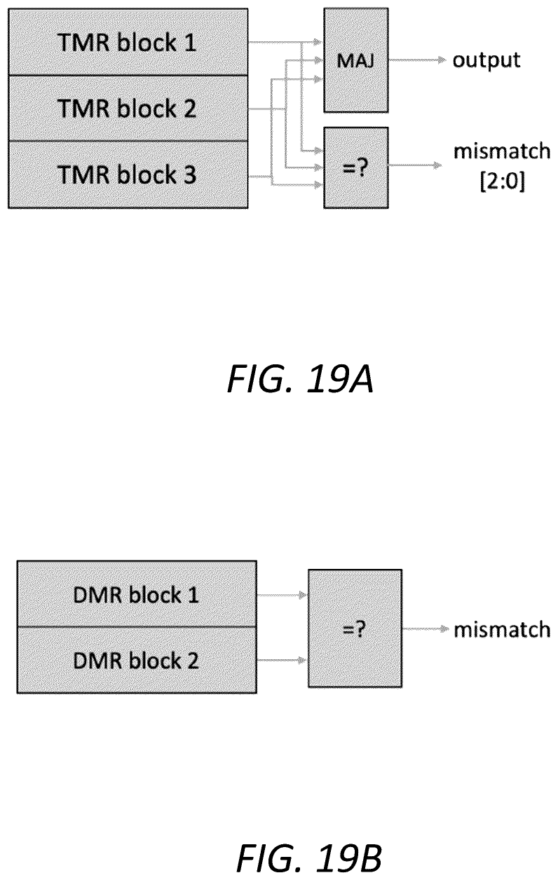

Applications 1702 on fabric 102 can directly communicate with error handler 106, which allows for redundant designs to report mismatches to error handler 106 and request a block-level or frame-level reconfiguration. For example, a faulty redundant block in a TMR implementation can be detected by comparing block outputs with each other, which application 1702 can then report to error handler 106 and request its reconfiguration. Redundant applications can interact with error handler 106 and request reconfiguration. FIG. 19A is a block diagram illustrating a comparison of TMR outputs to check whether a redundant block is faulty and then request reconfiguration of that particular redundant block. If none of the block outputs match, the application 1702 can stall and ask for reconfiguration of the entire fabric 102. FIG. 19B is a block diagram illustrating a mismatch in the DMR outputs, in which case the application is stalled and reconfiguration of the entire fabric 102 is requested.

On the other hand, a DMR implementation can report an output mismatch and request reconfiguration of the entire fabric 102. Additionally, if there is a mismatch in DMR outputs and an SEU is detected in one of the redundant blocks, the DMR application can use the sensor block information signal sent by error handler 106 to decide between the two outputs and continue the operation instead of waiting for reconfiguration to be completed.

The application 1702 can monitor a signal from error handler 106 to fabric 102 to determine when to stop stalling. This signal informs fabric 102 that a reconfiguration was completed by error handler 106 and stays high until error handler 106 receives an acknowledgement from fabric 102. Upon receiving the signal, application 1702 can resume, repeat the operation with the same inputs, and check whether the redundant block outputs match. If the outputs match, it means the correct operation has been restored. Otherwise, the application can stall again and request another reconfiguration from error handler 106. This scheme helps to implement robust redundant applications on the FPGA that do not fail with a mismatch in block outputs and can continue their operation after reconfiguration as long as the application can afford stalling.

The architecture of the radiation hardened FPGA has been disclosed. The FPGA incudes SEU sensors distributed in the configuration memory and an on-chip error handler used for error detection and correction. The FPGA fabric is formed by a 2D array of configurable logic blocks, switch boxes, and connection blocks. Configurable logic blocks consist of lookup tables and flip-flops that provide logic and storage functionality. Switch boxes and connection blocks are formed by programmable muxes and connect configurable logic blocks with each other,

The FPGA includes SEU sensors that detect errors in configuration cells with a low latency. If there is an error, the on-chip error handler receives an error flag, which it processes to determine the faulty sensor frame. Communicating with the memory, the error handler can identify which redundant block, if any, was implemented on the faulty sensor frame as well as which configuration frame needs to be reconfigured, Finally, the error handler reads the correct configuration data from the memory and reconfigures the faulty configuration frame.

A second error detection mode is detecting errors through the application implemented on the FPGA fabric, which has a higher latency than detecting through sensors and reconfiguring only a single configuration frame. For this functionality, the error handler receives a 3-bit signal from the fabric, and depending on the signal, it reconfigures either the part of the fabric on which the faulty redundant block and neutral blocks such as block output comparators are implemented, or it reconfigures the entire fabric. DMR and TMR applications can be modified to take advantage of this interface between the FPGA fabric and the error handler.

As would be realized by one of skill in the art, many variations in the designs discussed herein fall within the intended scope of the invention. Moreover, it is to be understood that the features of the various embodiments described herein are not mutually exclusive and can exist in various combinations and permutations, even if such combinations or permutations were not made express herein, without departing from the spirit and scope of the invention. Accordingly, the method and system disclosed herein are not to be taken as limitations on the invention but as an illustration thereof. The scope of the invention is defined by the claims which follow.

1. A radiation-hardened FPGA comprising:
an FPGA fabric comprising a plurality of configuration frames, each configuration frame containing a plurality of configuration cells;
one or more sensor circuits disposed in each of the plurality of configuration frames;
an error handler; and
memory containing redundant copies of the configuration frames;
wherein the error handler reconfigures one or more configuration frames when a sensor located in the configuration frame senses an error, the error handler copying one or more redundant configuration cells from the memory to the one or more configuration frames in the fabric.

2. The FPGA of claim 1 wherein the sensor circuits detect single event upset (SEU) errors.

3. The FPGA of claim 2 wherein the sensor circuits are tunable.

4. The FPGA of claim 3 wherein the sensor circuits are tuned to indicate an error at a radiation level less than a radiation level that would cause an SEU error in a configuration cell.

5. The FPGA of claim 1 wherein the sensor circuits are one at each end of each configuration frame and one in between every two configuration cells.

6. The FPGA of claim 1 wherein the outputs of all sensor circuits in a configuration frame are OR'd together to create an output error flag.

7. The FPGA of claim 6 wherein the fabric comprises a plurality of tiles, each tile comprising:
a configurable logic block;
a switch box; and
a pair of connection blocks;
wherein each of the configurable logic blocks, the switch boxes and the connection blocks each comprise a plurality of configuration frames.

8. The FPGA of claim 7 wherein each tile comprises:
a first sensor frame comprising the configurable logic block;
a second sensor frame comprising the switch box; and
a third sensor frame comprising the pair of connection blocks;
wherein the error flags from each configuration frame are OR'd together to create an error output for each sensor frame.

9. The FPGA of claim 8 wherein the memory further contains:
configuration data of the FPGA; and
sensor frame information.

10. The FPGA of claim 9 wherein the configuration data comprises:
bit line data for word lines of every configuration frame, mapped on the memory according to an ID for each configuration frame and number of the word lines.

11. The FPGA of claim 9 wherein the sensor frame information comprises:
a mapping between an ID for each sensor and the configuration frame wherein the sensor is located.

12. The FPGA of claim 1 further comprising:
dedicated I/O lines between the error handler and applications in the fabric.

13. The FPGA of claim 12 wherein the error handler performs the functions of:
receiving notification of an error from a sensor frame;
identifying the faulty sensor frame;
obtaining a correct configuration from the memory; and
reconfiguring the configuration frame associated with the faulty sensor frame or reconfiguring the entire fabric.

14. The FPGA of claim 13 wherein the faulty sensor frame is reconfigured when only errors from a single configuration frame have been received.

15. The FPGA of claim 13 wherein, when a notification of an error is received from an application running in the fabric, the error handler reconfigures pone block or the entire fabric, depending on a signal received from the fabric.

16. A method comprising:
receiving, at an error handler on a FPGA, an error signal indicating a single event upset (SEU) error in one or more configuration frames in a fabric of the FPGA;
determining one or more faulty configuration frames for reconfiguration based on an ID of one or more sensors detecting the SEU error;
retrieving, from a memory on the FPGA, redundant copies of the one or more faulty configuration frames; and
reconfiguring the one or more faulty configuration frames with the redundant copies.

17. The method of claim 16 further comprising:
resetting the one or more sensors detecting the SEU error.

18. The method of claim 16 wherein the sensors are tunable and further wherein the sensors are tuned to indicate an error at a radiation level less than a radiation level that would cause an SEU error in a configuration cell of a configuration frame.

19. The method of claim 16 wherein the memory is independent of the fabric and further wherein the memory contains:
configuration data of the FPGA;
sensor frame information; and
redundant copies of confogiurti9on frames in the fabric.

20. The method of claim 16 wherein the fabric comprises a plurality of tiles, each tile comprising:
a configurable logic block;
a switch box; and
a pair of connection blocks;
wherein each of the configurable logic blocks, the switch boxes and the connection blocks each comprise a plurality of configuration frames and further wherein each tile is arranged as:
a first sensor frame comprising the configurable logic block;
a second sensor frame comprising the switch box; and
a third sensor frame comprising the pair of connection blocks.
